(19) United States
(12) Patent Application Publication
(10) Pub. No.: US 2019/0092637 A1
(43) Pub. Date: Mar. 28, 2019

(54) OZONE SUPPLY DEVICE AND OZONE SUPPLY METHOD

(71) Applicant: MITSUBISHI ELECTRIC CORPORATION, Chiyoda-ku, Tokyo (JP)

(72) Inventors: Yusuke NAKAGAWA, Chiyoda-ku (JP); Yoko MATSUURA, Chiyoda-ku (JP); Noboru WADA, Chiyoda-ku (JP); Yasuhiro NAKAMURA, Chiyoda-ku (JP)

(73) Assignee: MITSUBISHI ELECTRIC CORPORATION, Chiyoda-ku, Tokyo (JP)

(21) Appl. No.: 15/772,593

(22) PCT Filed: Nov. 14, 2016
(86) PCT No.: PCT/JP2016/083678

§ 371 Date: May 1, 2018

(30) Foreign Application Priority Data
Jan. 28, 2016 (JP) 2016-013893

(51) Int. Cl. C01B 13/10; B01D 53/047; B01D 53/04

(52) U.S. Cl. CPC C01B 13/10; B01D 53/047; B01D 53/0454; B01D 2259/4525; B01D 2256/14; B01D 2259/40009; B01D 2253/106

(57) ABSTRACT

This ozone supply device includes an ozone generator, an adsorption tower, a standby unit, a pressure reducing device, an ozone supply unit, a low-temperature coolant circulator, and a control unit which causes a generated ozonized gas to be adsorbed to a cooled adsorbent and desorbs the ozonized gas adsorbed to the adsorbent, thereby concentrating the ozonized gas, wherein the control unit performs control so that the pressure in the adsorption tower in a standby state where the ozonized gas desorbed from the adsorbent in the adsorption tower is caused to stand by in the standby unit becomes lower than the pressure in the adsorption tower in the adsorption.

### TECHNICAL FIELD

The present invention relates to an ozone supply device and an ozone supply method for concentrating and storing ozone using an adsorption phenomenon.

### BACKGROUND ART

Ozone is used as a strong oxidizing agent in a wide variety of fields such as water environment purification and semiconductor cleaning. With increase in environmental awareness in recent years, technology for efficiently generating concentrated ozone is increasingly required. The upper limit value of the purity of ozone generated by an ozone generator alone is about 20% in volume fraction. Since ozone has a property of self-decomposition, it is difficult to store ozone in a gas phase at ordinary temperature. In order to perform ozone processing intermittently, it is necessary to generate ozone each time. Methods of storing and concentrating ozone using an adsorption phenomenon and intermittently supplying high-purity ozonized gas are disclosed (for example, Patent Documents 1, 2). In addition, in order to desorb stored ozone, a method of reducing the pressure of an adsorption tower (for example, Patent Document 3), and a method of raising the temperature of an adsorption tower (for example, Patent Document 2), are disclosed. In the inventions disclosed in Patent Documents 1 to 3, desorption of ozone is performed after requested. Therefore, there is a problem that it is impossible to supply ozone immediately in response to the request for ozone.

In this regard, the following method is disclosed: a standby step of performing preliminary heating before ozone desorption is provided, thereby starting desorption immediately in response to the request and supplying ozone (for example, Patent Document 4).

### CITATION LIST

### Patent Document

Patent Document 1: Japanese Laid-Open Patent Publication No. 11-43307 (paragraphs [0018] to [0023] and FIG. 1)

Patent Document 2: Japanese Examined Patent Publication No. 61-011881 (page 2, right column, page 3, right column to page 4, right column, and FIGS. 3, 5)

Patent Document 3: Japanese Patent No. 3837280 (paragraph [0017] and FIG. 1)

Patent Document 4: Japanese Examined Patent Publication No. 63-013928 (page 2, right column to page 3, left column, and FIG. 2)

### SUMMARY OF THE INVENTION

### Problems to be Solved by the Invention

However, in the invention disclosed in Patent Document 4, there is a problem that ozone usage efficiency decreases due to ozone self-decomposition in the standby step.

The present invention has been made to solve the above problem, and an object of the present invention is to provide an ozone supply device and an ozone supply method that enable improvement in responsiveness of supply of concentrated ozone upon an ozone request and enable increase in ozone usage efficiency.

### Solution to the Problems

An ozone supply device according to the present invention includes: an ozone generator for generating an ozonized gas; an adsorption tower for causing the generated ozonized gas to be adsorbed to an adsorbent inside the adsorption tower; a standby unit for causing the ozonized gas desorbed from the adsorbent in the adsorption tower to stand by; a pressure reducing device for reducing pressures of the adsorption tower and the standby unit; an ozone supply unit for supplying the desorbed ozonized gas to a supply target; a low-temperature coolant circulator for cooling the adsorbent; and a control unit which controls a gas flow in a gas flow path connecting the ozone generator, the adsorption tower, the standby unit, and the pressure reducing device, so as to cause the generated ozonized gas to be adsorbed to the cooled adsorbent, and to desorb the ozonized gas adsorbed to the adsorbent, thereby concentrating ozone, wherein the control unit performs control so that a pressure in the adsorption tower in a standby state where the desorbed ozonized gas is caused to stand by in the standby unit becomes lower than a pressure in the adsorption tower in the adsorption.

An ozone supply method according to the present invention uses an ozone supply device including an ozone generator, an adsorption tower the inside of which is filled with an adsorbent, a standby unit for causing an ozonized gas to stand by, a pressure reducing device, an ozone supply unit for supplying the ozonized gas, and a low-temperature coolant circulator for cooling the adsorbent, the ozone supply method including: an adsorption step of introducing an ozonized gas generated by the ozone generator into the adsorption tower, and causing the ozonized gas to be adsorbed to the cooled adsorbent; a concentration step of reducing a pressure of the adsorption tower by the pressure reducing device, to increase ozone purity of a gas in the adsorption tower; a standby step of sealing a concentrated high-purity ozonized gas inside the adsorption tower and the standby unit having reduced pressures, and standing by; and a supply step of supplying the high-purity ozonized gas.

### Effect of the Invention

The ozone supply device according to the present invention includes the standby unit for causing the ozonized gas desorbed from the adsorbent in the adsorption tower to stand by, and therefore it is possible to immediately supply a high-purity ozonized gas at an optional timing, suppress self-decomposition of ozone during the standby state, and increase the ozone usage efficiency.

The ozone supply method according to the present invention includes the standby step of sealing the concentrated high-purity ozonized gas inside the adsorption tower and the standby unit and standing by, and therefore it is possible to immediately supply a high-purity ozonized gas at an optional timing, suppress self-decomposition of ozone during the standby state, and increase the ozone usage efficiency.

### BRIEF DESCRIPTION OF THE DRAWINGS

FIG. 1 is a system schematic diagram showing the configuration of an ozone supply device according to embodiment 1 of the present invention.

FIG. 2 is a flowchart of an ozone supply method according to embodiment 1 of the present invention.

FIG. 3 illustrates a comparative example for the ozone supply device according to embodiment 1 of the present invention.

FIG. 4 is a process schematic diagram of the ozone supply device according to embodiment 1 of the present invention.

FIG. 5 is a process schematic diagram of the comparative example for the ozone supply device according to embodiment 1 of the present invention.

FIG. 6 is a system schematic diagram showing another configuration of the ozone supply device according to embodiment 1 of the present invention.

FIG. 7 is a system schematic diagram showing another configuration of the ozone supply device according to embodiment 1 of the present invention.

FIG. 8 is a system schematic diagram showing another configuration of the ozone supply device according to embodiment 1 of the present invention.

FIG. 9 is a system schematic diagram showing another configuration of the ozone supply device according to embodiment 1 of the present invention.

FIG. 10 is a system schematic diagram showing the configuration of an ozone supply device according to embodiment 2 of the present invention.

FIG. 11 is a characteristics diagram showing a relationship between the pressure in an adsorption tower and ozone purity, in the ozone supply device according to embodiment 2 of the present invention.

FIG. 12 is a system schematic diagram showing the configuration of an ozone supply device according to embodiment 3 of the present invention.

FIG. 13 is a system schematic diagram showing the configuration of an ozone supply device according to embodiment 4 of the present invention.

FIG. 14 is a system schematic diagram showing the configuration of an ozone supply device according to embodiment 5 of the present invention.

FIG. 15 is a system schematic diagram showing the configuration of an ozone supply device according to embodiment 6 of the present invention.

FIG. 16 is a system schematic diagram showing the configuration of an ozone supply device according to embodiment 7 of the present invention.

FIG. 17 is a system schematic diagram showing the configuration of an ozone supply device according to embodiment 9 of the present invention.

### DESCRIPTION OF EMBODIMENTS

### Embodiment 1

Embodiment 1 relates to an ozone supply device including: an ozone generator; an adsorption tower the inside of which is filled with an adsorbent; a standby unit for causing an ozonized gas to stand by; a pressure reducing device; an ozone supply unit for supplying an ozonized gas; a low-temperature coolant circulator for cooling an adsorbent; and a control unit which causes an ozonized gas to be adsorbed to an adsorbent, and desorbs the ozonized gas adsorbed to the adsorbent, to concentrate the ozonized gas.

Embodiment 1 also relates to an ozone supply method including an adsorption step, a concentration step, a standby step, and a supply step.

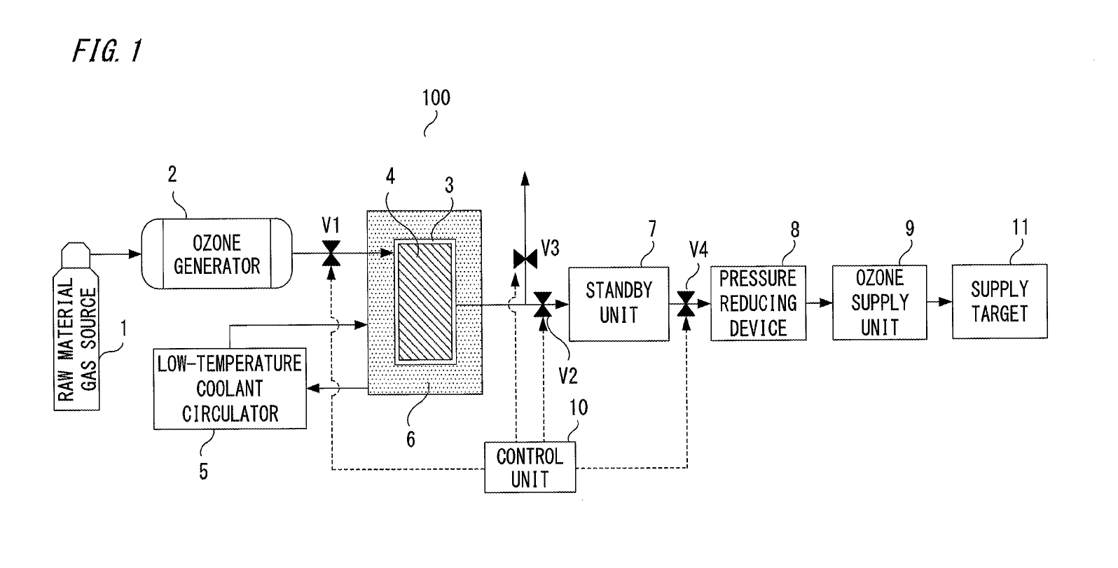

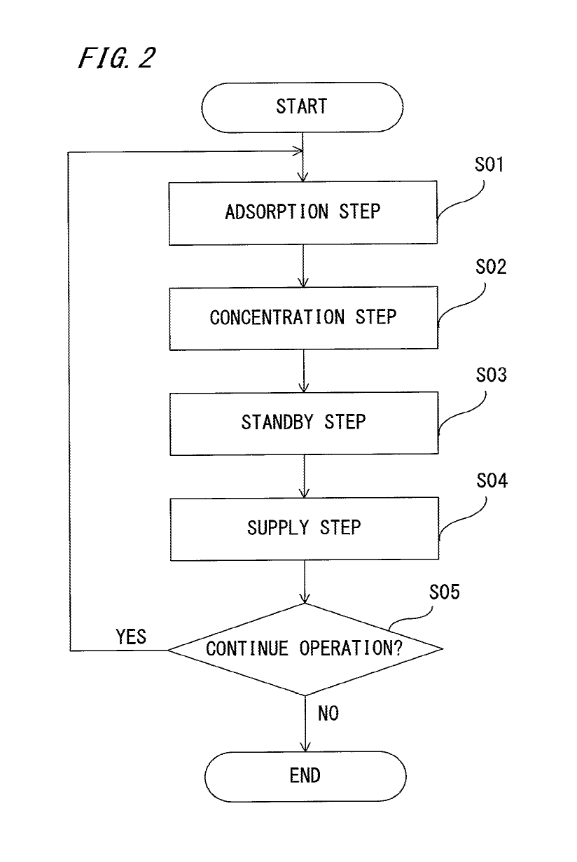

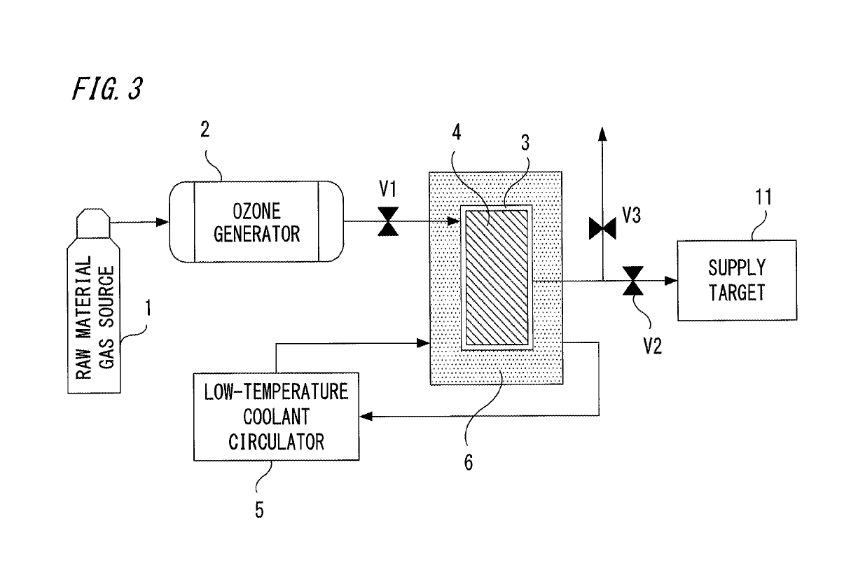

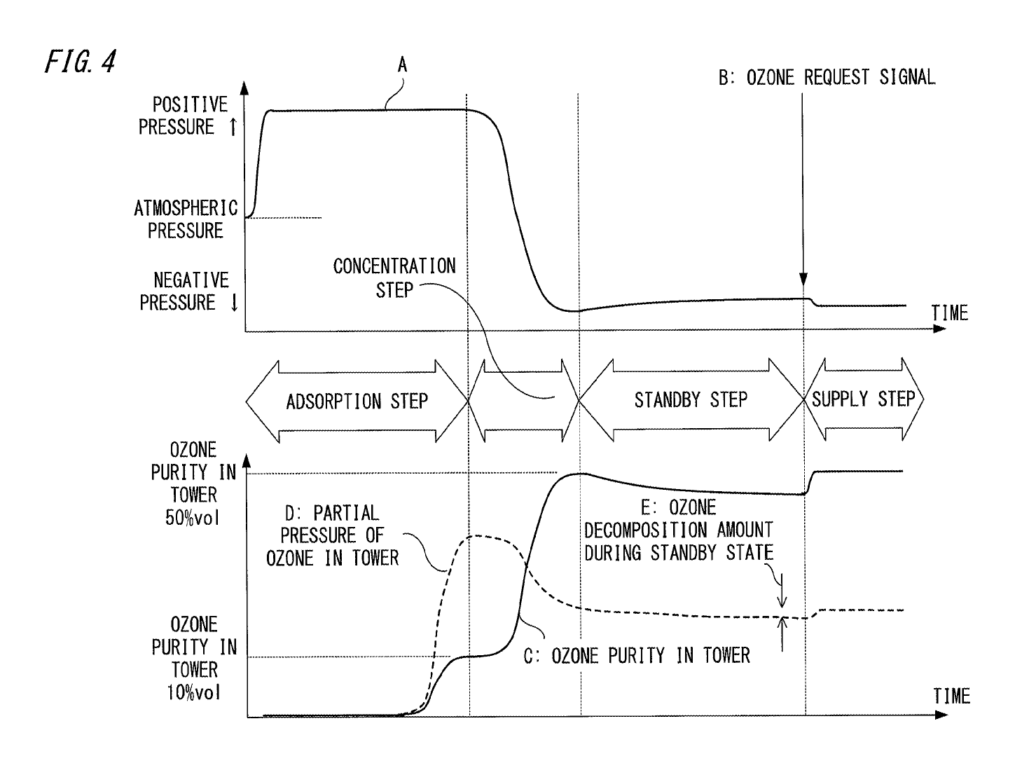

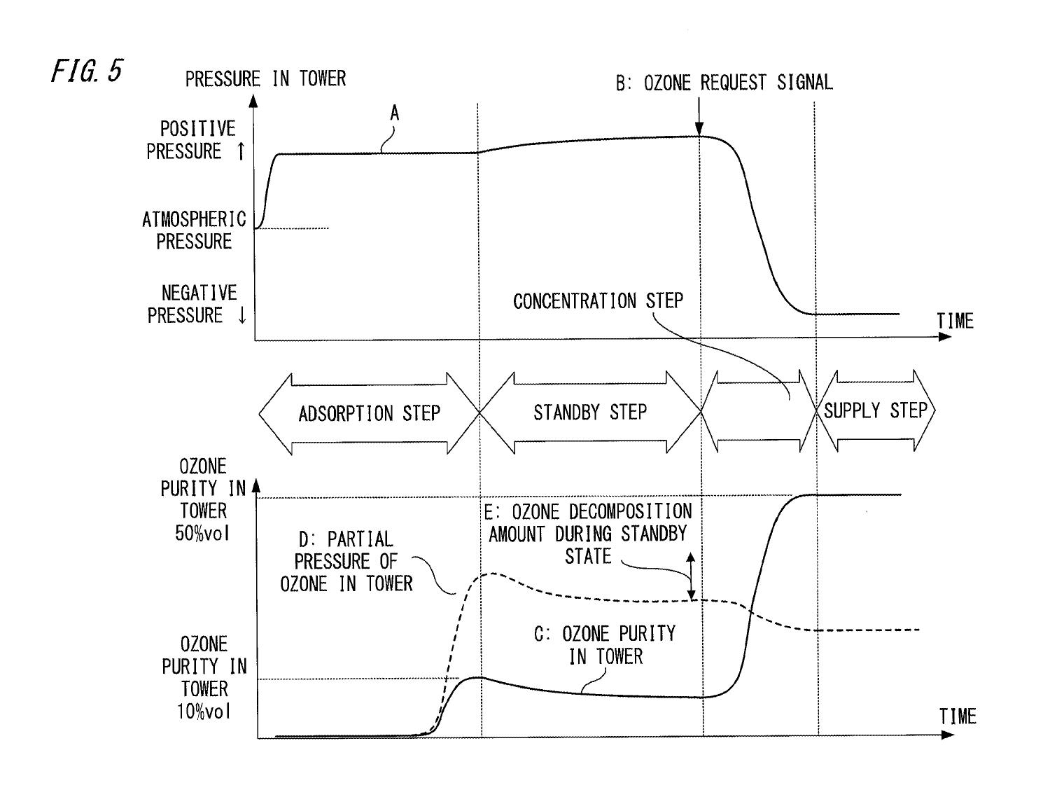

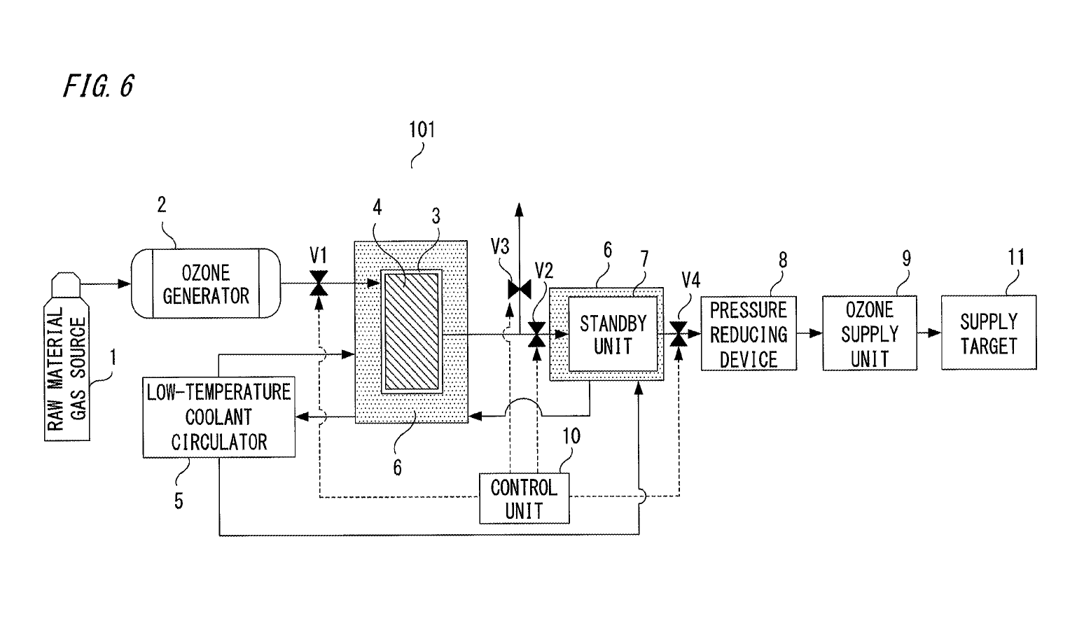

Hereinafter, the configuration of the ozone supply device and the ozone supply method according to embodiment 1 will be described with reference to FIG. 1 which is a system schematic diagram showing the configuration of the ozone supply device, FIG. 2 which is a flowchart of the ozone supply method, FIG. 3 which illustrates a comparative example, FIG. 4 which is a process schematic diagram of the ozone supply device, FIG. 5 which is a process schematic diagram of the comparative example, and FIG. 6 to FIG. 9 which are system schematic diagrams showing other configurations of the ozone supply device.

In the system schematic diagrams, the same or corresponding parts are denoted by the same reference character.

In explanation of embodiment 1, the configuration and the process summary of an ozone supply device in a comparative example will also be described for the purpose of clarifying the features of the ozone supply device and the ozone supply method of embodiment 1.

In the description, ozone purity is a term indicating the ratio of the number of ozone particles to the total number of particles in a subject gas, and the partial pressure of ozone is a term indicating the absolute number of ozone particles contained in unit volume, and thus they are discriminated.

First, the configuration of the ozone supply device of embodiment 1 will be described with reference to FIG. 1.

FIG. 1 is a system schematic diagram showing the configuration of the ozone supply device. The ozone supply device 100 includes a raw material gas source 1, an ozone generator 2, an adsorption tower 3, a low-temperature coolant circulator 5, a standby unit 7, a pressure reducing device 8, an ozone supply unit 9, and a control unit 10.

A raw material gas containing oxygen is introduced from the raw material gas source 1 into the ozone generator 2, and the raw material gas is ozonized. The ozonized gas is introduced into the adsorption tower 3 the inside of which is filled with an adsorbent 4, and ozone in the ozonized gas is adsorbed to the surface of the adsorbent 4.

The adsorption tower 3 is surrounded by a low-temperature coolant 6, and the low-temperature coolant circulator 5 circulates the low-temperature coolant 6 to cool the adsorption tower 3, thereby keeping the temperature of the adsorbent 4 at a low temperature.

The outer wall of the standby unit 7 is thermally insulated from the outside air by being coated with a heat insulating material or by means of vacuum insulation, for example, thereby preventing temperature increase of the ozonized gas sealed in the standby unit 7.

It is desirable that the inner wall surfaces of the adsorption tower 3 and the standby unit 7 are passivated by being exposed to an ozonized gas having a partial pressure of ozone higher than the partial pressure of ozone to be used, before the ozone supply device 100 is actually used. Passivating the inner wall surfaces of the adsorption tower 3 and the standby unit 7 can suppress ozone decomposition caused by contact between the inner wall surface and ozone.

At an adsorption tower inlet of a gas flow path connecting the ozone generator 2 and the adsorption tower 3, a valve V1 is provided. At a standby unit inlet of a gas flow path connecting the adsorption tower 3 and the standby unit 7, a valve V2 is provided, and this gas flow path is provided with a valve V3 for extracting gas and discharging the gas to outside of the system. At a pressure reducing device inlet of a gas flow path connecting the standby unit 7 and the pressure reducing device 8, a valve V4 is provided. The valves V1 to V4 are control valves and are controlled to be opened/closed by the control unit 10. That is, the control unit 10 controls the valves V1 to V4 which are control valves, thereby controlling the gas flow in the gas flow paths.

The ozonized gas generated by the ozone supply device 100 is supplied from the ozone supply unit 9 to a supply target 11.

Next, operation of the ozone supply device 100 will be described.

Operation of the ozone supply device 100 includes: an adsorption step of causing ozone to be adsorbed to the cooled adsorbent 4; a concentration step of reducing the pressure of the adsorption tower 3 filled with the adsorbent 4, to increase the ozone purity of the gas in the adsorption tower 3; a standby step of sealing the concentrated high-purity ozonized gas in the adsorption tower 3 and the standby unit 7 and standing by for an optional time period; and a supply step of supplying the high-purity ozonized gas to the supply target 11.

Next, operation in each of the adsorption step, the concentration step, the standby step, and the supply step will be specifically described.

In the adsorption step, the raw material gas containing oxygen is introduced from the raw material gas source 1 into the ozone generator 2, and the ozone generator 2 ozonizes the raw material gas. The control unit 10 opens the valve V1 and the valve V3 and closes the valve V2 and the valve V4, the ozonized gas is introduced into the adsorption tower 3, and ozone is adsorbed to the cooled adsorbent 4.

As the adsorbent 4, a material that adsorbs ozone in priority to gas components, such as oxygen, nitrogen, and nitrogen oxide, (hereinafter, referred to as raw material gas components) other than ozone contained in the ozonized gas, is selected. As the adsorbent 4, silica gel is used, for example. Owing to the adsorption property of the adsorbent 4, the ozone purity at the surface of the adsorbent 4 becomes higher than the ozone purity in the ozonized gas.

The lower the temperature of the adsorbent 4 is, the greater the amount of ozone adsorbed to the adsorbent 4 is. Therefore, the low-temperature coolant circulator 5 circulates the low-temperature coolant 6 around the adsorption tower 3, to keep the temperature of the adsorbent 4 at a low temperature. Ozone and the raw material gas components that have failed to be adsorbed are discharged through the valve V3 to outside of the system.

When a predetermined condition is satisfied, e.g., the amount of ozone adsorbed to the adsorbent 4 reaches a certain amount, a certain time period elapses, or a step shift signal is inputted from outside, the process shifts to the concentration step.

In the concentration step, the raw material gas components adsorbed to the adsorbent 4 is preferentially desorbed and discharged, whereby the ozone purity is increased. In the concentration step, the valve V1 and the valve V3 are closed and the valve V2 and the valve V4 are opened, and the pressure in the adsorption tower 3 is reduced using the pressure reducing device 8.

As the pressure reducing device 8, a vacuum pump or an ejector is used, for example. In the case of using a vacuum pump as the pressure reducing device 8, since the secondary side of the vacuum pump has a positive pressure, it is not necessary to make the pressure of the supply target 11 lower than the pressure of the adsorption tower 3, and thus the degree of freedom of the supply target 11 is increased.

Owing to the adsorption property of the adsorbent 4, the desorption rate of ozone from the adsorbent 4 is lower than the desorption rate of the raw material gas components from the adsorbent 4. Therefore, when the pressure of the adsorption tower 3 is reduced, the raw material gas components other than ozone in the adsorption tower 3 are preferentially discharged, so that the ozone purity in the adsorption tower 3 increases.

Thus, if the pressure reducing device 8 such as a vacuum pump that has a positive pressure on the secondary side is provided at a stage preceding to the supply target 11, it is possible to supply the ozonized gas to the supply target 11 in a state in which the pressure in the adsorption tower 3 is lower than the gas-phase pressure of the supply target 11.

In the standby step, the control unit 10 closes the valve V1, the valve V3, and the valve V4, and the ozonized gas in the adsorption tower 3 having ozone purity increased through the concentration step is sealed in the adsorption tower 3 and the standby unit 7.

The control unit 10 keeps the valve V1, the valve V3, and the valve V4 closed during an optional time period, to stand by for an ozone request signal.

Next, the supply step will be described.

When a set condition is satisfied, e.g., a predetermined optional time period elapses or an ozone request signal is inputted from outside, the ozone supply device 100 shifts to the supply step to supply the high-purity ozonized gas to the supply target 11 by the ozone supply unit 9 while keeping the adsorption tower 3 at a negative pressure using the pressure reducing device 8.

In the case where the supply target 11 requests a gas-phase ozone, the ozone supply unit 9 is, for example, a gas pipe or an ejector, and in the case where the supply target 11 requests liquid-phase ozone, the ozone supply unit 9 is, for example, a diffuser pipe or an ejector. In the case of using an ejector, one ejector may serve the functions of the pressure reducing device 8 and the ozone supply unit 9.

A process for generating and supplying a high-purity ozonized gas by applying the ozone supply method including the adsorption step, the concentration step, the standby step, and the supply step as described above will be described with reference to the flowchart in FIG. 2.

The ozone supply method of the present embodiment 1 includes the following steps 1 (S01) to 4 (S04), which are performed using the ozone supply device 100 including the ozone generator 2, the adsorption tower 3 the inside of which is filled with the adsorbent 4, the standby unit 7 for causing an ozonized gas to stand by, the pressure reducing device 8, and the ozone supply unit 9 for supplying the ozonized gas to the supply target.

It is noted that the flowchart in FIG. 3 has operation continuation determination processing added in step 5 (S05), thereby allowing continuation of operation.

In the adsorption step of step 1 (S01), an ozonized gas generated in the ozone generator 2 is introduced into the adsorption tower 3, and the ozonized gas is adsorbed to the cooled adsorbent 4.

In the concentration step of step 2 (S02), the pressure of the adsorption tower 3 is reduced by the pressure reducing device 8, to increase the ozone purity of the gas in the adsorption tower 3.

In the standby step of step 3 (S03), the concentrated high-purity ozonized gas is sealed in the adsorption tower 3 and the standby unit 7, to stand by during an optional time period.

In the supply step of step 4 (S04), the high-purity ozonized gas is supplied from the ozone supply unit 9.

In step 5 (S05), whether or not to continue the operation is determined. If the operation is continued, the process returns to the adsorption step of step 1 (S01). If the operation is not continued, the operation of the ozone supply device 100 is finished.

Here, a general configuration of the ozone supply device in the comparative example will be described with reference to FIG. 3.

The ozone supply device in the comparative example includes the raw material gas source 1, the ozone generator 2, the adsorption tower 3, and the low-temperature coolant circulator 5, and supplies the concentrated ozonized gas to the supply target 11.

The gas ozonized by being introduced from the raw material gas source 1 into the ozone generator 2 is introduced into the adsorption tower 3 filled with the adsorbent 4, and ozone in the ozonized gas is adsorbed to the surface of the adsorbent 4. The low-temperature coolant circulator 5 circulates the low-temperature coolant 6 to cool the adsorption tower 3, thereby keeping the temperature of the adsorbent 4 at a low temperature. In the adsorption step, the valve V1 and the valve V3 are opened and the valve V2 is closed, and when a predetermined amount of ozone is adsorbed to the adsorbent, generation of ozone is stopped. At the time of supplying ozone to the supply target 11, the valve V1 and the valve V3 are closed and the valve V2 is opened, and ozone is desorbed from the adsorbent 4 in the adsorption tower 3, thereby intermittently supplying the high-purity ozonized gas.

Here, as typical methods for desorbing ozone, there are a method of reducing the pressure of the adsorption tower 3 and a method of increasing the temperature of the adsorption tower 3.

In the ozone supply device of the comparative example, since it is not necessary to continuously operate the ozone generator 2, power consumption and raw material gas consumption can be suppressed, and it is possible to supply a high-purity (purity of 50% or higher) ozonized gas which cannot be generated by the ozone generator alone.

However, in the ozone supply device of the comparative example, desorption of ozone is started after ozone is requested. Therefore, there is a problem that it is impossible to supply ozone immediately in response to an ozone request from the supply target 11.

In the ozone supply device 100 of the present embodiment 1, what is important is not merely having the standby unit 7 and the standby step but also providing the standby step between the ozone supply step and the concentration step in which the pressure of the adsorption tower 3 is reduced. In a conventional concentrated ozonized gas supply device, ozone self-decomposition reaction during a standby state has not been focused on, and therefore the order of the standby step has not been set appropriately. In addition, the pressure reducing device 8 needs to operate in both the concentration step and the supply step, and therefore it is general to perform the concentration step and the supply step continuously.

In contrast, in the present invention, the standby unit 7 is provided just before the pressure reducing device 8, and the high-purity ozonized gas after the concentration step is caused to stand by in the standby unit 7. Thus, it is possible to reduce a time lag after receiving an ozone request from the supply target 11 to supply of the high-purity ozone, and greatly suppress self-decomposition of ozone in the standby step.

The effect obtained by providing the standby unit 7 and providing the standby step after the concentration step in the ozone supply device 100 of embodiment 1 will be described with reference to the process schematic diagrams in FIGS. 4 and 5.

FIG. 4 shows an example of temporal changes in the pressure, the ozone purity, and the partial pressure of ozone in the adsorption tower 3 in each of the adsorption step, the concentration step, the standby step, and the supply step, in the ozone supply device 100 of embodiment 1.

In FIG. 4, A indicates the pressure in the adsorption tower 3, and B indicates an ozone request signal. C indicates the ozone purity in the adsorption tower 3, D indicates the partial pressure of ozone in the adsorption tower 3, and E indicates the ozone decomposition amount during the standby state. It is noted that the ozone decomposition amount (E) during the standby state corresponds to difference in the partial pressure of ozone in the adsorption tower 3 between the start and the end of the standby step.

FIG. 5 shows an example of temporal change in the pressure, the ozone purity, and the partial pressure of ozone in the adsorption tower 3, in the ozone supply device of the comparative example in which the standby step is provided before the concentration step.

In FIG. 5, A indicates the pressure in the adsorption tower 3, and B indicates an ozone request signal. C indicates the ozone purity in the adsorption tower 3, D indicates the partial pressure of ozone in the adsorption tower 3, and E indicates the ozone decomposition amount during the standby state. Also in FIG. 5, the ozone decomposition amount (E) during the standby state corresponds to difference in the partial pressure of ozone in the adsorption tower 3 between the start and the end of the standby step.

In the ozone supply device 100 of embodiment 1, as shown in FIG. 4, the ozonized gas in the adsorption tower 3 after the concentration step has high ozone purity, and therefore, by keeping the high ozone purity in the standby step, it is possible to supply the high-purity ozonized gas immediately at the time of shifting to the supply step. In addition, in the standby step, the pressure of the adsorption tower 3 has been reduced, so that the ozone purity is high but the partial pressure of ozone is low as compared to the adsorption step. It is noted that, in the standby step, the pressure of the standby unit 7 as well as the adsorption tower 3 has been reduced.

On the other hand, in the ozone supply device of the comparative example, as shown in FIG. 5, in the standby step, the ozone purity in the adsorption tower 3 is low but the partial pressure of ozone is high. Therefore, when supply of ozone is requested, the concentration step is performed, and thus a time lag occurs. In addition, from the difference in the ozone decomposition amount (E) during the standby state between FIG. 4 and FIG. 5, it is obvious that ineffective consumption due to ozone self-decomposition during the standby state is great.

As described above, in the ozone supply device 100 of embodiment 1, ozone self-decomposition reaction is suppressed and the generated ozone can be effectively used. Hereinafter, the effect of suppressing ozone self-decomposition reaction will be described.

First, ozone self-decomposition reaction and the ozone self-decomposition reaction rate will be described.

The ozone self-decomposition reaction is a phenomenon in which ozone particles react with each other before reacting with a processing target, and thus return to oxygen molecules. If ozone self-decomposition reaction occurs, the usage efficiency of the generated ozone decreases.

The ozone self-decomposition reaction in a gas phase is constituted of a plurality of elementary reactions of ozone (O₃), oxygen molecule (O₂), oxygen atom (O), and the like, but generally, is represented by Equation 1.

O₃+O₃→3O₂ (Equation 1)

While there have been a few report examples of a reaction rate coefficient k_{R} for Equation 1, “NIST Chemical Kinetics Database, Standard Reference Database 17, Version 7.0 (Web Version) Release 1.6.8 http://kinetics.nist.gov/kinetics/” has reported the following value:

k_{R}=7.47×10⁻¹²×exp(−9310/T) [cm⁶/s] (Equation 2),

where T [K] is the temperature.

An ozone self-decomposition reaction rate v_{R} is represented by the following equation:

v_{R}=k_{R}×Coz² [/s] (Equation 3),

where Coz [/cm³] is the partial pressure of ozone.

That is, even under the same ozone purity, the self-decomposition reaction becomes faster as the temperature increases and as the partial pressure of ozone increases.

For example, in the case where the ozone purity is 10%, the partial pressure of ozone at 2 atm is twice as high as the partial pressure of ozone at the atmospheric pressure, and therefore the ozone self-decomposition reaction rate at 2 atm is four times as high as the ozone self-decomposition reaction rate at the atmospheric pressure. Here, if ozone is caused to stand by with the temperature of the adsorption tower increased, the temperature in the adsorption tower in the standby step becomes higher than that in the adsorption step, and ozone self-decomposition progresses faster. Thus, the usage efficiency of the generated ozone is reduced.

Next, effects as compared to the ozone supply device of the comparative example will be specifically described through calculation of the ozone self-decomposition reaction rate in the ozone supply device 100 of embodiment 1.

First, regarding the ozone supply device of the comparative example, the ozone self-decomposition rate during the standby state will be calculated. In the comparative example, the standby step is entered without starting ozone desorption, and in the standby step, the temperature is 0 degrees Celsius, and the ozone purity is equal to or greater than 35 wt %=26 vol % at the atmospheric pressure. At this time, the partial pressure of ozone is Coz=7.09×10¹⁸ [/cm³]. Therefore, from Equation 3, the ozone self-decomposition rate is v_{R}=3.57×10¹¹ [/s].

On the other hand, in the ozone supply device 100 of embodiment 1, for example, in the case where adsorption is performed with ozone purity of 9.3 vol % at −15 degrees Celsius, ozone purity of 47 vol % is obtained by reducing the pressure in the adsorption tower 3 to an absolute pressure of 20 kPa.

The ozone supply device 100 shifts to the standby step in a state in which the pressure of the adsorption tower 3 is reduced and ozone is desorbed, and therefore, the partial pressure of ozone in the standby step is Coz=2.76×10¹⁸ [/cm³]. In addition, in the concentration step and the standby step, the temperatures of the adsorption tower 3 and the standby unit 7 are not increased, and therefore the temperatures of the adsorption tower 3 and the standby unit 7 are −15 degrees Celsius or lower, and the ozone self-decomposition rate v_{R} is 7.26×10⁹ [/s] or lower. That is, as compared to the ozone self-decomposition rate in the case of shifting to the standby step at a high temperature and with a high partial pressure of ozone as in the ozone supply device of the comparative example, in the ozone supply device 100 of embodiment 1, the ozone self-decomposition rate in the standby step becomes about 1/50, and thus ozone consumption in the standby step is greatly reduced.

As described above, in embodiment 1, the ozone supply device 100 is provided with the standby unit 7 for causing an ozonized gas to stand by in a high ozone purity state, and the ozone supply method is provided with the standby step for causing an ozonized gas to stand by in a high ozone purity state. Therefore, it is possible to supply a high-purity ozonized gas immediately when an ozone request occurs from the supply target 11. Further, in the standby step, the adsorption tower 3 and the standby unit 7 are kept in a pressure-reduced state and the self-decomposition rate of ozone is decreased, whereby ozone consumption during the standby state is reduced and the ozone usage efficiency is increased.

Next, ozone supply devices having different configurations from the ozone supply device 100 of embodiment 1 will be sequentially described.

First, an ozone supply device 101 shown in the system schematic diagram in FIG. 6 will be described.

The difference from the ozone supply device 100 is that the standby unit 7 is cooled by the low-temperature coolant 6. Thus, by cooling the standby unit 7 by the low-temperature coolant 6, the temperature of the standby unit 7 in the standby step becomes a low temperature equivalent to the temperature of the adsorption tower 3, so that the ozone self-decomposition rate in the standby unit 7 is decreased. Therefore, the usage efficiency of the stored ozone is increased.

In the ozone supply device 101 in FIG. 6, the low-temperature coolant 6 flows through the standby unit 7 and then the adsorption tower 3. However, the flow direction may be reversed, or the adsorption tower 3 and the standby unit 7 may be cooled in parallel.

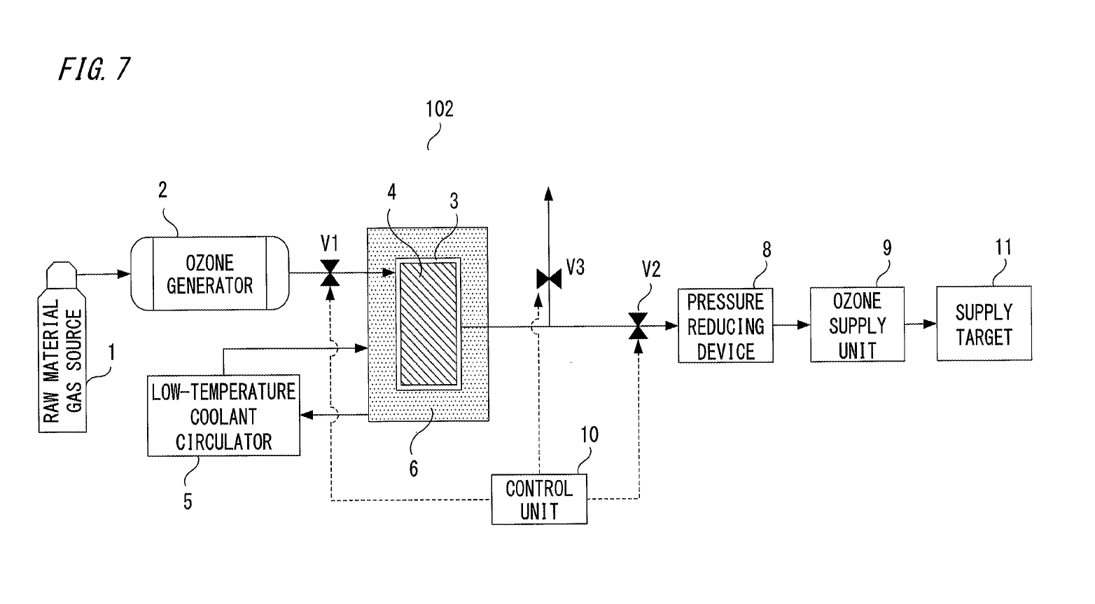

Next, an ozone supply device 102 shown in the system schematic diagram in FIG. 7 will be described.

The difference from the ozone supply device 100 is that the adsorption tower 3 also has a function as the standby unit 7.

In the concentration step, the pressure of the adsorption tower 3 is reduced, and then when the pressure in the adsorption tower 3 becomes lower than a predetermined value, the control unit 10 closes the valve V2 to seal the adsorption tower 3, and then shifts to the standby step. In the standby step, since the inside of the adsorption tower 3 is in a pressure-reduced state, the ozone self-decomposition rate can be kept small.

In the case where the adsorption tower 3 also has a function as the standby unit 7 as described above, responsiveness of supply of high-purity ozone upon an ozone request from the supply target 11 is slightly decreased as compared to the ozone supply device 100. However, since the standby unit 7 and the valve V4 are not provided, the number of members needed for the ozone supply device is decreased and valve control by the control unit 10 is simplified.

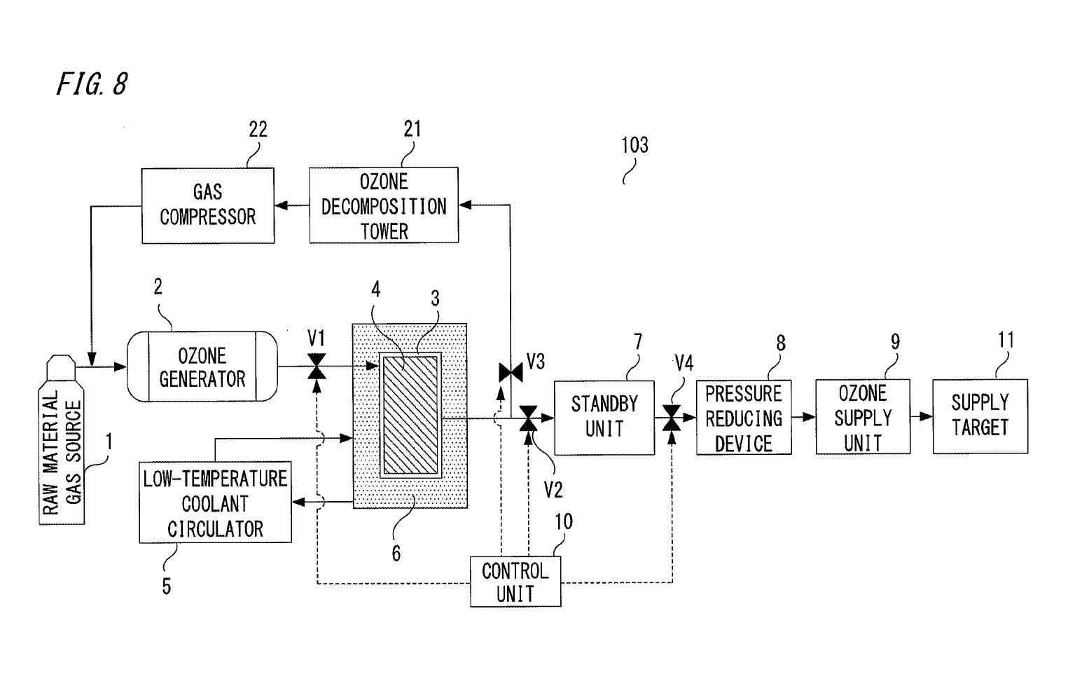

Next, an ozone supply device 103 shown in the system schematic diagram in FIG. 8 will be described.

The difference from the ozone supply device 100 is that a path through which a gas discharged from the adsorption tower 3 in the adsorption step is circulated and introduced into the ozone generator 2 again is provided.

The ozonized gas (hereinafter, referred to as a discharged gas) discharged from the adsorption tower 3 in the adsorption step is introduced into an ozone decomposition tower 21 through the valve V3. Ozone in the ozonized gas that has failed to be adsorbed to the adsorbent 4 is decomposed in the ozone decomposition tower 21, to become oxygen.

Since the discharged gas contains oxygen, the discharged gas can be reused as a raw material gas. Therefore, the discharged gas that has passed through the ozone decomposition tower 21 is, after the pressure thereof is increased by a gas compressor 22, introduced as a raw material gas into the ozone generator 2 again.

In this way, if the discharged gas discharged from the adsorption tower 3 is circulated and introduced into the ozone generator 2 again, the raw material gas is reused, whereby ozone manufacturing cost is reduced.

In the case where, in the adsorption step, ozone in the ozonized gas is entirely adsorbed to the adsorbent 4 so that ozone is not contained in the gas discharged from the adsorption tower, the ozone decomposition tower 21 may be omitted.

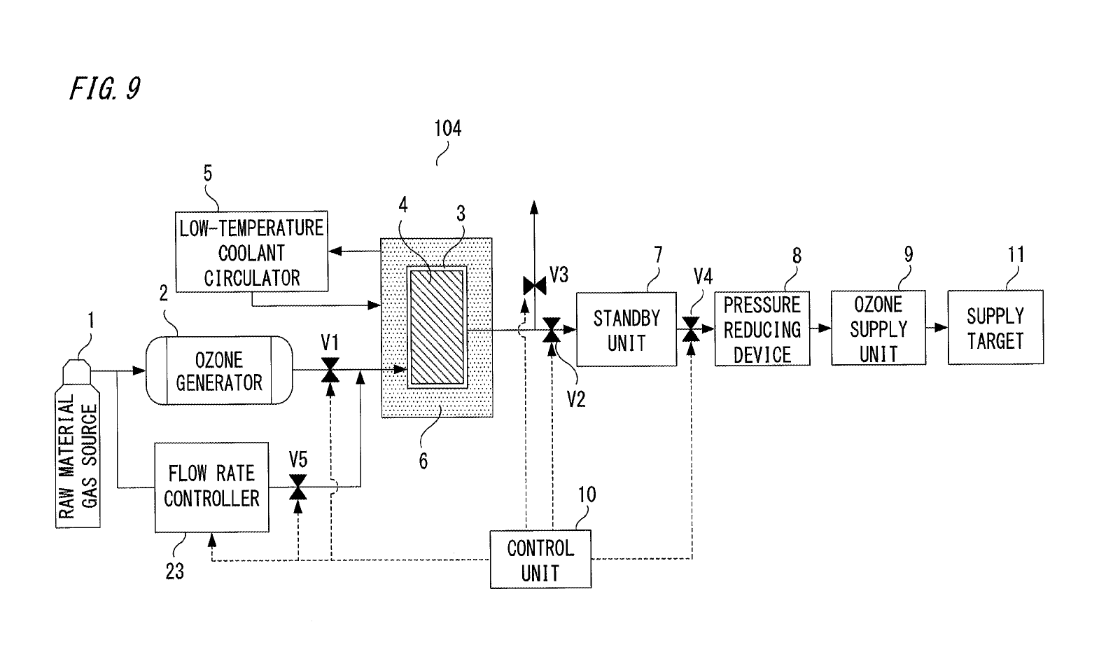

Next, an ozone supply device 104 shown in the system schematic diagram in FIG. 9 will be described.

The difference from the ozone supply device 100 is that the ozone supply device 104 has a branch path for supplying the raw material gas from the raw material gas source 1 to the adsorption tower 3 not via the ozone generator 2, and a flow rate controller 23 for controlling the flow rate of the raw material gas in the branch path.

The ozone purity of the ozonized gas outputted from the ozone supply device corresponds to the pressure in the adsorption tower 3 in the supply step on a one-to-one basis. However, unless the pressure reducing device 8 or the ozone supply unit 9 has a pressure adjustment function, the ozonized gas having the maximum ozone purity is always outputted in the supply step.

In the ozone supply device 104, in the ozone supply step, the raw material gas is introduced into the adsorption tower 3 and the flow rate of the raw material gas is changed to adjust the pressure in the adsorption tower 3, whereby the purity of ozone in the ozonized gas to be desorbed from the adsorbent 4 can be controlled.

Employing the configuration of the ozone supply device 104 makes it possible to supply an ozonized gas to the supply target 11 at desired purity equal to or lower than the maximum generated ozone purity even if the pressure reducing device 8 and the ozone supply unit 9 do not have a pressure adjustment function.

As described above, the ozone supply device 100 of embodiment 1 includes: the ozone generator; the adsorption tower the inside of which is filled with an adsorbent; the standby unit for causing an ozonized gas to stand by; the pressure reducing device; the ozone supply unit for supplying the ozonized gas; the low-temperature coolant circulator which cools the adsorbent; and the control unit which causes the ozonized gas to be adsorbed to the adsorbent, and desorbs the ozonized gas adsorbed to the adsorbent, to concentrate the ozonized gas, wherein the standby unit causes the ozonized gas to stand by in a high ozone purity state. In addition, the ozone supply method includes the adsorption step, the concentration step, the standby step, and the supply step, wherein, in the standby step, the ozonized gas is caused to stand by in a high ozone purity state.

Therefore, the ozone supply device and the ozone supply method of embodiment 1 make it possible to supply a high-purity ozonized gas immediately when an ozone request occurs from the supply target. Further, in the standby step, the adsorption tower and the standby unit are kept in a pressure-reduced state, and the self-decomposition rate of ozone is reduced, whereby ozone consumption during the standby state is reduced and the ozone usage efficiency is increased.

### Embodiment 2

An ozone supply device of embodiment 2 is configured by adding a pressure gauge to the ozone supply device 100 of embodiment 1, thereby controlling the pressure in the adsorption tower 3 and the standby unit 7.

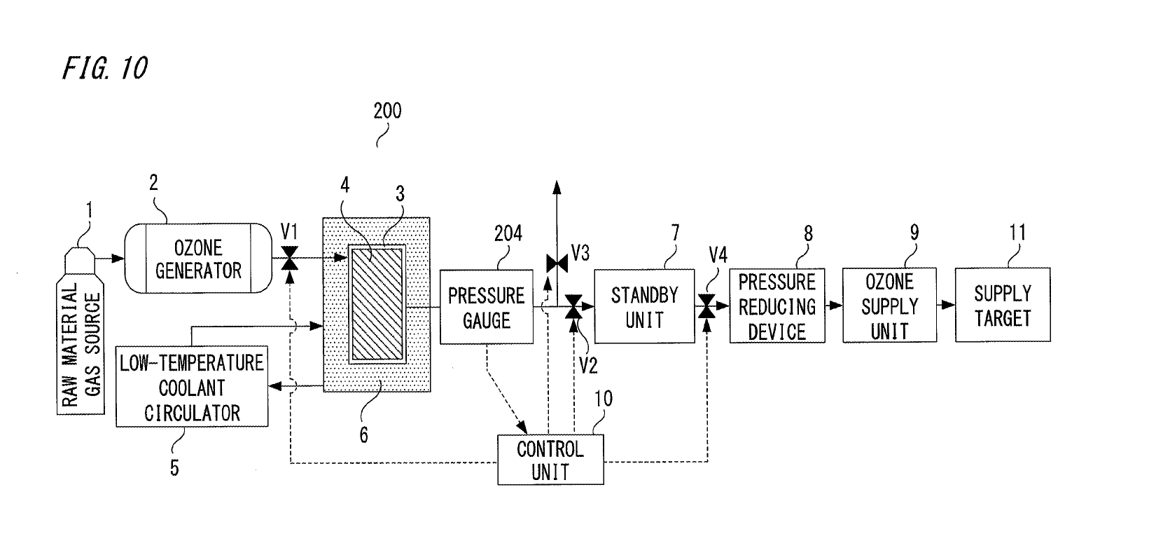

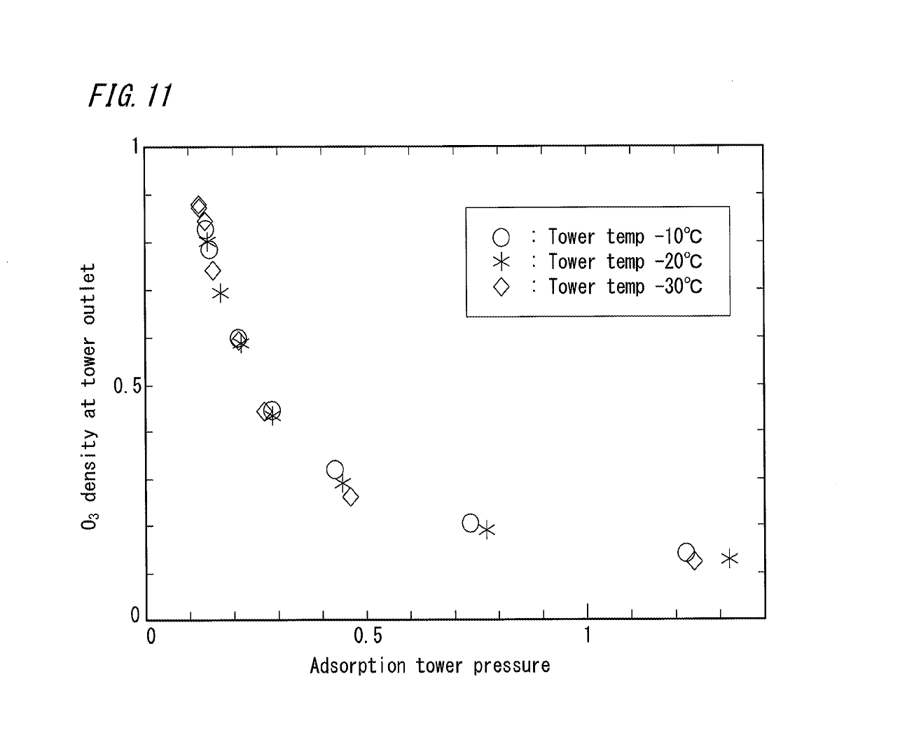

Hereinafter, the ozone supply device of embodiment 2 will be described focusing on the difference from embodiment 1, with reference to FIG. 10 which is a system schematic diagram showing the configuration thereof and FIG. 11 which is a characteristics diagram showing the relationship between the pressure in the adsorption tower and the ozone purity. In FIG. 10, parts that are the same as or correspond to those in FIG. 1 in embodiment 1 are denoted by the same reference characters.

The basic configuration of the ozone supply device in embodiment 2 is the same as that of the ozone supply device 100 in embodiment 1, but in the ozone supply device 200, a pressure gauge 204 is provided at the stage subsequent to the adsorption tower 3. The pressure gauge 204 measures the pressure at the stage subsequent to the adsorption tower 3 in the concentration step, and transmits the measurement result to the control unit 10.

On the condition that the measurement value of the pressure gauge 204 has become smaller than a predetermined pressure value in the concentration step, the control unit 10 outputs a command for shifting to the standby step.

Here, the inventors have found that, in the concentration step and the supply step, the ozone purity of the ozonized gas outputted from the adsorption tower 3 uniquely depends on the pressure in the adsorption tower 3 without depending on the temperature in the adsorption tower 3.

FIG. 11 shows the dependency of the ozone purity of the supplied ozonized gas on the pressure in the adsorption tower 3 when the temperature in the adsorption tower 3 is changed, and it is clearly shown that the dependency does not change by the temperature in the adsorption tower 3. It is noted that, in FIG. 11, the horizontal axis indicates the pressure (arbitrary unit) in the adsorption tower, and the vertical axis indicates the ozone density (arbitrary unit) at the outlet of the adsorption tower.

From the above result, it is found that, by setting pressure values corresponding to desired ozone purity in advance, it is possible to shift to the standby step at desired ozone purity even if the temperature of the adsorption tower 3 changes. Thus, it becomes possible to perform high-speed control by controlling the ozone purity in the adsorption tower 3 by referring to the pressure value.

In the present embodiment 2, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 2 is configured by adding the pressure gauge to the ozone supply device of embodiment 1, thereby controlling the pressure in the adsorption tower and the standby unit. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, by performing process control by referring to the pressure, high-speed control responsiveness can be obtained.

### Embodiment 3

An ozone supply device of embodiment 3 is configured by adding an ozone meter to the ozone supply device 100 of embodiment 1, thereby controlling the ozone purity and the partial pressure of ozone in the adsorption tower 3 and the standby unit 7.

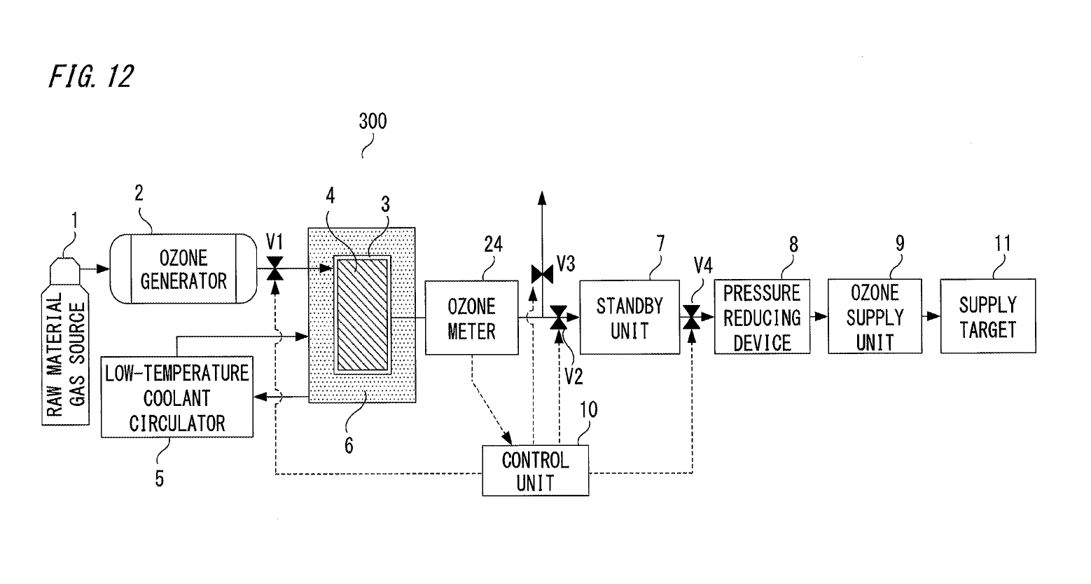

Hereinafter, the ozone supply device of embodiment 3 will be described focusing on the difference from embodiment 1, with reference to FIG. 12 which is a system schematic diagram showing the configuration thereof. In FIG. 12, parts that are the same as or correspond to those in FIG. 1 in embodiment 1 are denoted by the same reference characters.

The basic configuration of the ozone supply device 300 in embodiment 3is the same as that of the ozone supply device 100 in embodiment 1, but in the ozone supply device 300, an ozone meter 24 is provided at the stage subsequent to the adsorption tower 3.

The ozone meter 24 measures the ozone purity and the partial pressure of ozone in the adsorption tower 3 in the concentration step, and transmits the measurement result to the control unit 10.

The control unit 10 allows shifting to the standby step when the following two conditions are both satisfied.

(Condition 1) The ozone purity in the adsorption tower 3 in the concentration step has reached purity equal to or greater than predetermined target ozone purity.

(Condition 2) The partial pressure of ozone in the adsorption tower 3 in the concentration step is lower than the partial pressure of ozone in the adsorption tower 3 in the adsorption step.

If (Condition 1) is satisfied, it is possible to supply a high-purity ozonized gas immediately at the time of shifting from the standby step to the supply step. In addition, if (Condition 2) is satisfied, ozone self-decomposition in the standby step is suppressed.

In the control unit 10, it is possible to set the respective values of the ozone purity and the partial pressure of ozone as conditions for allowing shifting from the concentration step to the standby step. By setting shift-allowed conditions of the ozone purity and the partial pressure of ozone, it becomes possible to control the partial pressure of ozone at the time of shifting from the concentration step to the standby step, thereby obtaining an effect of suppressing ozone self-decomposition to a desired degree.

In the ozone supply device 300 of embodiment 3, shifting to the standby step is allowed when two conditions of the ozone purity and the partial pressure of ozone are satisfied. However, shifting to the standby step may be allowed when one of the conditions is satisfied.

In the present embodiment 3, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 3 is configured by adding the ozone meter to the ozone supply device of embodiment 1, thereby controlling the ozone purity and the partial pressure of ozone in the adsorption tower and the standby unit. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, the ozone self-decomposition rate can be optionally controlled, thereby obtaining an effect of increasing the ozone usage efficiency to a desired degree.

### Embodiment 4

An ozone supply device of embodiment 4 is configured by adding a thermometer and a coolant temperature control unit for controlling the temperature of a low-temperature coolant, to the ozone supply device 100 of embodiment 1.

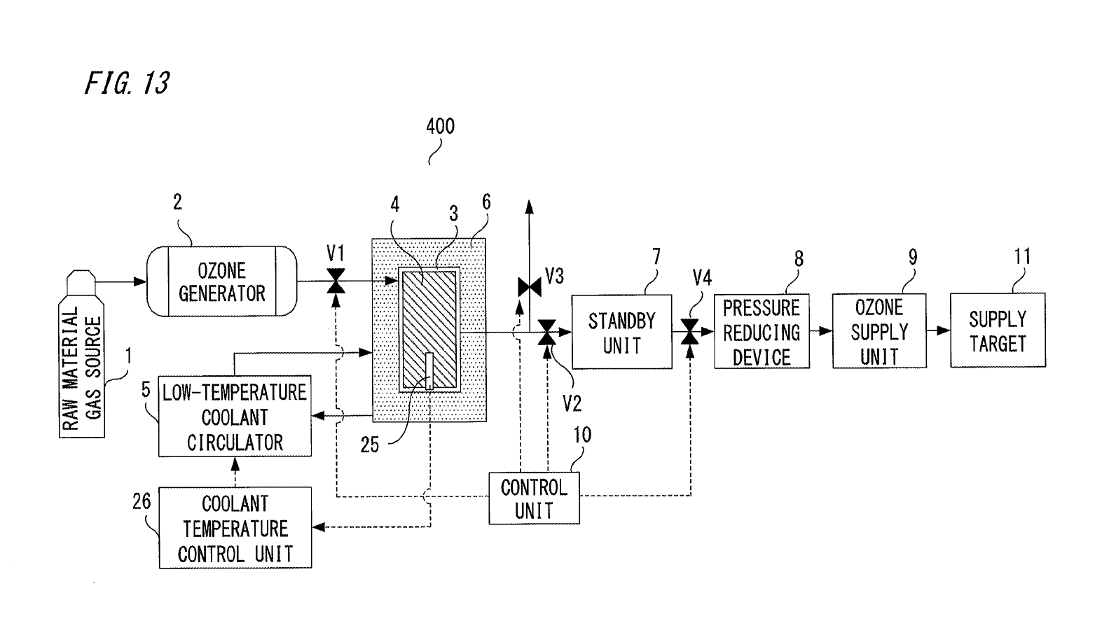

Hereinafter, the ozone supply device of embodiment 4 will be described focusing on the difference from embodiment 1, with reference to FIG. 13 which is a system schematic diagram showing the configuration thereof. In FIG. 13, parts that are the same as or correspond to those in FIG. 1 in embodiment 1 are denoted by the same reference characters.

The basic configuration of the ozone supply device 400 in embodiment 4 is the same as that of the ozone supply device 100 in embodiment 1, but the ozone supply device 400 is provided with a thermometer 25 for measuring the temperature in the adsorption tower 3, and a coolant temperature control unit 26 for controlling the temperature of the low-temperature coolant 6. The control unit 10 controls the temperature in the adsorption tower 3, using the thermometer 25 and the coolant temperature control unit 26.

In the present embodiment 4, the temperature in the adsorption tower 3 in the standby step is set to a temperature equal to or lower than the temperature in the adsorption tower 3 in the adsorption step. Thus, the self-decomposition rate coefficient of ozone represented by Equation 2 in the standby step is decreased, and ozone self-decomposition is suppressed. Actually, when ozone and raw material gas components are desorbed from the adsorbent 4, heat of vaporization is taken from the adsorbent 4 and the ambient gas, so that the inside of the adsorption tower 3 is naturally cooled in the concentration step. Therefore, it is considered that the amount of cold heat needed for the low-temperature coolant 6 is extremely small.

It is preferable that difference in the ozone decomposition amount between the case of performing cooling of the adsorption tower 3 in the standby step and the case of not performing the cooling is calculated, the power cost needed for the cooling is compared with the ozone generation cost corresponding to the difference in the ozone decomposition amount, and the temperature of the adsorption tower 3 in the standby step is set so that the power cost for the cooling becomes smaller than the ozone generation cost.

In the present embodiment 4, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 4 is configured by adding the thermometer and the coolant temperature control unit for controlling the temperature of the low-temperature coolant, to the ozone supply device of embodiment 1. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, the self-decomposition rate coefficient of ozone during the standby state is decreased, whereby ozone self-decomposition can be suppressed.

### Embodiment 5

An ozone supply device of embodiment 5 is configured by adding a communication unit for performing signal transmission/reception between the supply target and the control unit, to the ozone supply device 100 of embodiment 1.

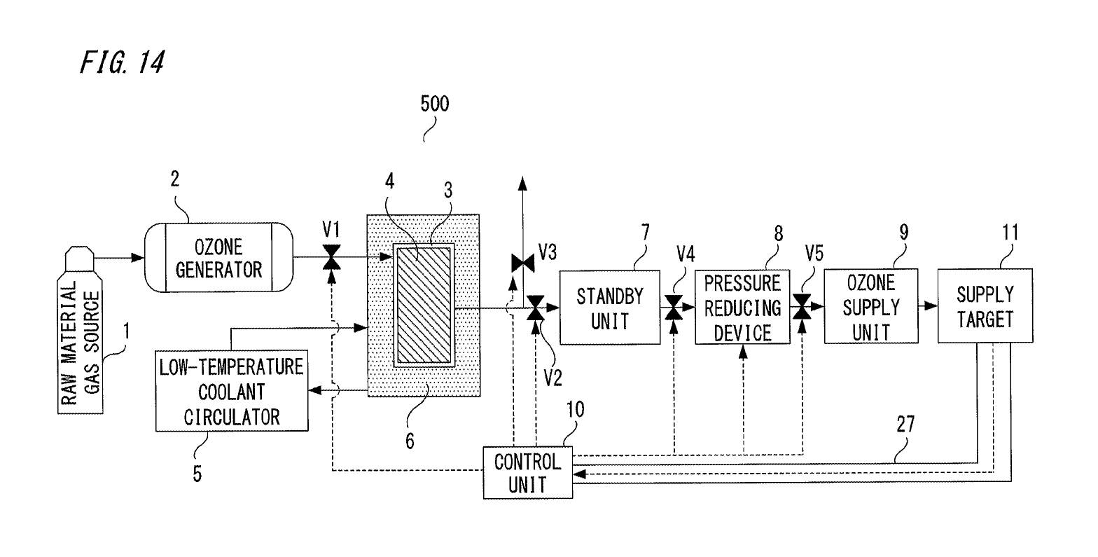

Hereinafter, the ozone supply device of embodiment 5 will be described focusing on the difference from embodiment 1, with reference to FIG. 14 which is a system schematic diagram showing the configuration thereof. In FIG. 14, parts that are the same as or correspond to those in FIG. 1 in embodiment 1 are denoted by the same reference characters.

The basic configuration of the ozone supply device 500 in embodiment 5 is the same as that of the ozone supply device 100 in embodiment 1, but the ozone supply device 500 is provided with a communication unit 27 for performing signal transmission/reception between the supply target 11 and the control unit 10. Further, a valve V5 is provided on a gas flow path connecting the pressure reducing device 8 and the ozone supply unit 9.

In a state in which the adsorption step and the concentration step have been completed in advance and the process has shifted to the standby step, the control unit 10 stands by for an ozone request signal. When ozone is needed, the supply target 11 outputs an ozone request signal, and the ozone request signal is inputted to the control unit 10 through the communication unit 27.

When having received the ozone request signal, the control unit 10 starts operation of the pressure reducing device 8 and at the same time, opens the valves V4 and V5, to supply the high-purity ozone to the supply target 11.

In addition, an ozone discharge valve may be provided at the stage subsequent to the valve V5, and the ozonized gas discharged from the pressure reducing device in the concentration step may be discharged from the ozone discharge valve. In this case, it is possible to discharge, from the ozone discharge valve, an ozonized gas having purity equal to or lower than set purity in the concentration step. Thus, an ozonized gas having purity equal to or lower than set purity is prevented from being supplied to the supply target 11, whereby an ozonized gas having stable purity can be supplied to the supply target 11.

In the present embodiment 5, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 5 is configured by adding the communication unit for performing signal transmission/reception between the supply target and the control unit, to the ozone supply device of embodiment 1. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, the following effect is obtained: even if a load of ozone processing sharply varies in the supply target and the need of ozone suddenly arises, it is possible to supply high-purity ozone immediately.

### Embodiment 6

An ozone supply device of embodiment 6 includes a plurality of standby units 7 in parallel, under the assumption of supplying ozonized gases to a plurality of supply targets.

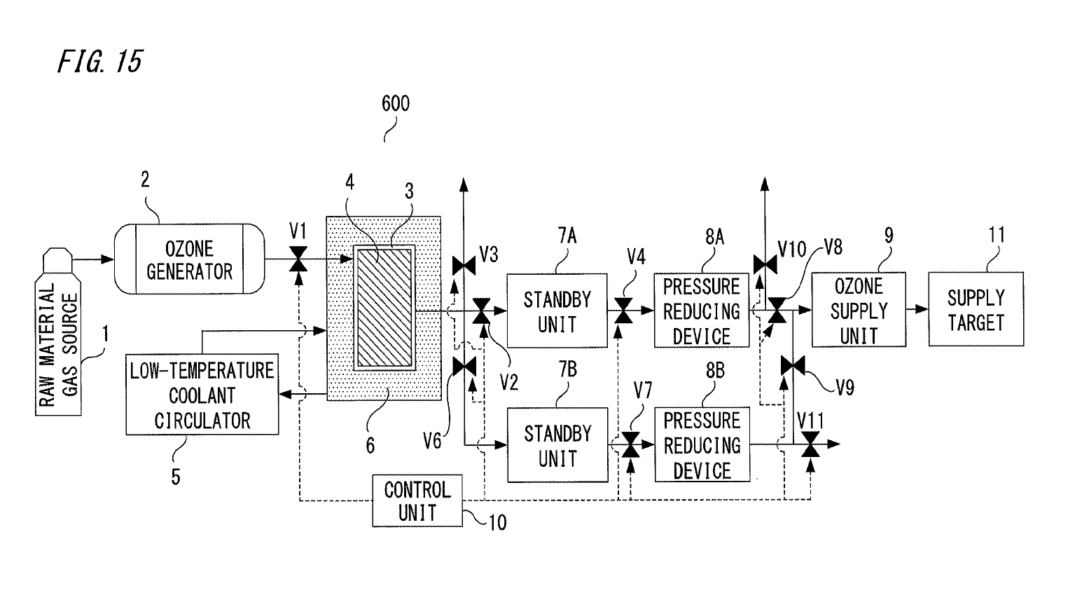

Hereinafter, the ozone supply device of embodiment 7 will be described focusing on the difference from embodiment 1, with reference to FIG. 15 which is a system schematic diagram showing the configuration thereof. In FIG. 15, parts that are the same as or correspond to those in FIG. 1 in embodiment 1 are denoted by the same reference characters.

The basic configuration of the ozone supply device 600 of embodiment 6 is the same as that of the ozone supply device 100 of embodiment 1, but the ozone supply device 600 is provided with two standby units (first standby unit 7A, second standby unit 7B) and two pressure reducing devices (first pressure reducing device 8A, second pressure reducing device 8B) in parallel.

In the ozone supply device 600, a valve V6 is provided on a gas flow path connecting the adsorption tower 3 and the second standby unit 7B, a valve V7 is provided on a gas flow path connecting the second standby unit 7B and the second pressure reducing device 8B, a valve V8 is provided on a gas flow path connecting the first pressure reducing device 8A and the ozone supply unit 9, and a valve V9 is provided on a gas flow path connecting the second pressure reducing device 8B and the ozone supply unit 9. Further, a valve V10 for discharging a gas to outside of the system is provided at the outlet of the first pressure reducing device 8A, and a valve V11 for discharging a gas to outside of the system is provided at the outlet of the second pressure reducing device 8B.

In the ozone supply device 600, the control unit 10 controls the valves V1 to V4 and V6 to V11, thereby supplying a high-purity ozonized gas to the supply target 11.

The ozone supply device 600 including the two standby units (first standby unit 7A, second standby unit 7B) and the two pressure reducing devices (first pressure reducing device 8A, second pressure reducing device 8B) causes ozone stored in the adsorption step to stand by in the first standby unit 7A, using the first pressure reducing device 8A. Thereafter, at a desired timing, the valve V3 and the valve V10 are closed and the valve V8 is opened, to supply the high-purity ozonized gas to the supply target 11.

While the high-purity ozonized gas is being supplied from the standby unit 7A, ozone is stored in the adsorption tower 3 and thereafter the high-purity ozonized gas is caused to stand by in the second standby unit 7B, using the second pressure reducing device 8B. After supply of the high-purity ozonized gas from the first standby unit 7A is completed, the valves V6, V8, V10, V11 are closed and the valve V9 is opened, to supply the high-purity ozonized gas from the standby unit 7B to the supply target 11. In this way, it becomes possible to continuously supply the high-purity ozonized gas to the supply target 11.

In FIG. 15, the first standby unit 7A and the second standby unit 7B supply the gas to the same supply target 11. However, the standby units (first standby unit 7A, second standby unit 7B) may respectively supply the gases to individual supply targets. In addition, also in the case where three or more standby units are provided, the same operation is performed in which, while an ozonized gas is being supplied from one standby unit, ozone is stored in the adsorption tower 3 and thereafter the ozonized gas is caused to stand by in another standby unit.

Also regarding the adsorption tower 3, a plurality of adsorption towers corresponding to the respective standby units may be provided. In this case, while an ozonized gas is being supplied from one adsorption tower, ozone can be stored in another adsorption tower. Therefore, there is no waste of time.

In embodiment 6, the ozone supply device having two standby units (first standby unit 7A, second standby unit 7B) and two pressure reducing devices (first pressure reducing device 8A, second pressure reducing device 8B) in parallel, has been described. However, a configuration of having two standby units and one pressure reducing device may be employed, and in this case, by providing a bypass gas flow path and performing switching by a valve, it is possible to continuously supply the high-purity ozonized gas to the supply target 11.

In the present embodiment 6, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 6 is configured by providing a plurality of standby units and a plurality of pressure reducing devices in the ozone supply device of embodiment 1. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, in the case where the supply target issues an ozone request for a long time, it is possible to continuously supply the high-purity ozonized gas. In addition, also in the case where there are a plurality of supply targets, it is possible to supply high-purity ozonized gases to the respective supply targets at optional timings.

### Embodiment 7

An ozone supply device of embodiment 7 is configured by adding a storage unit for storing at least one of an ozone supply interval and an ozone supply time, to the ozone supply device 100 of embodiment 1.

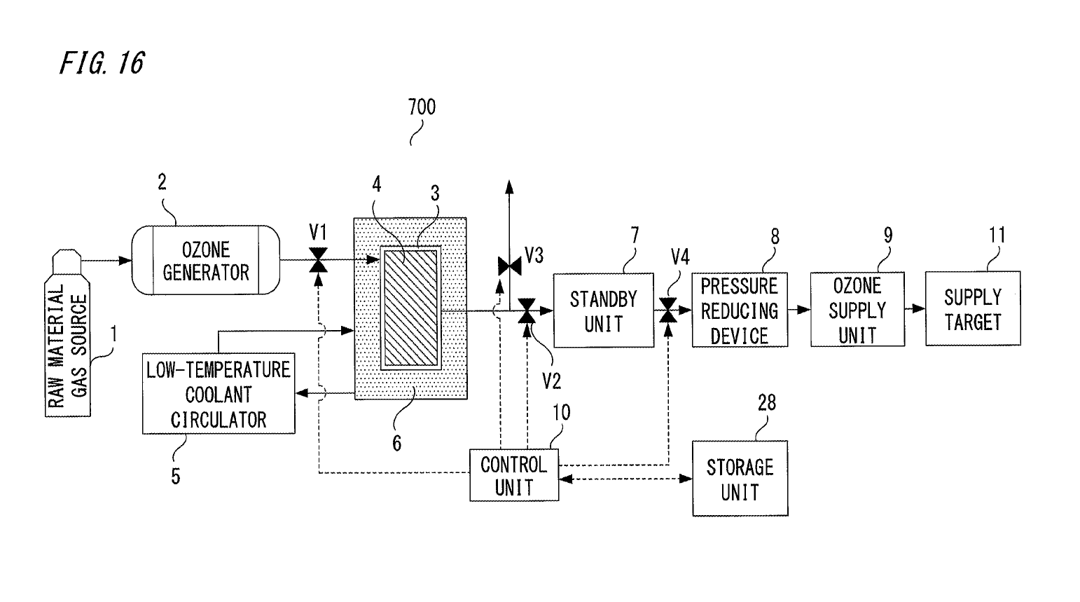

Hereinafter, the ozone supply device of embodiment 7 will be described focusing on the difference from embodiment 1, with reference to FIG. 16 which is a system schematic diagram showing the configuration thereof. In FIG. 16, parts that are the same as or correspond to those in FIG. 1 in embodiment 1 are denoted by the same reference characters.

The basic configuration of the ozone supply device 700 in embodiment 7 is the same as that of the ozone supply device 100 in embodiment 1, but the ozone supply device 700 is provided with a storage unit 28 for storing at least one of an ozone supply interval and an ozone supply time.

The storage unit 28 estimates a time interval until the next ozone supply, using data of ozone supply intervals or ozone supply times accumulated therein, and transmits the estimated time interval to the control unit 10.

Alternatively, the storage unit 28 may transmit data of ozone supply intervals or ozone supply times to the control unit 10, and the control unit 10 may estimate a time interval until the next ozone supply.

After having obtained the time interval until the next ozone supply, the control unit 10 controls the ozone generator 2, the adsorption tower 3, and the valves V1 to V4 so that, just before a predicted time when the next ozone supply is started, the adsorption step and the concentration step are finished to shift to the standby step.

In the ozone supply device 700 (FIG. 16), the storage unit 28 is provided outside the control unit 10. However, the control unit 10 may also have a function as the storage unit 28.

In addition, if the storage unit 28 stores not only ozone supply intervals but also the purity of supplied ozone, the flow rate of supplied ozonized gas, the ozonized gas purity in the adsorption step, the pressure in the adsorption tower 3 in the adsorption step, and the like, it becomes easy to output the ozonized gas with the same condition also in the next ozone supply, and thus a time required for adjustment of these parameters can be shortened.

In the present embodiment 7, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 7 is configured by adding the storage unit for storing at least one of an ozone supply interval and an ozone supply time, to the ozone supply device of embodiment 1. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, since the standby period in the standby step can be shortened, the ozone self-decomposition amount is reduced, whereby the ozone usage efficiency can be increased.

### Embodiment 8

In an ozone supply device of embodiment 8, the inner wall surfaces of the adsorption tower 3 and the standby unit 7 are subjected to a surface process in order to suppress ozone decomposition inside the adsorption tower 3 and the standby unit 7.

The ozone supply device of embodiment 8 will be described focusing on the difference from embodiment 1, with reference to FIG. 1 which is the system schematic diagram showing the basic configuration of the ozone supply device.

In the ozone supply device 1 of embodiment 1, the partial pressure of ozone is low in the standby step, and therefore, as compared to a state in which the partial pressure of ozone is high, ozone self-decomposition in a gas phase is suppressed, and an influence of ozone decomposition reaction at the wall surfaces of the adsorption tower 3 and the standby unit 7 relatively increases.

The ozone supply device of embodiment 8 has the adsorption tower 3 and the standby unit 7 having inner wall surfaces subjected to a surface process for suppressing ozone decomposition.

As the surface process for suppressing ozone decomposition, a process of reducing surface irregularity by mechanical polishing, electropolishing, or the like, or a process of reducing chemical reactivity at the surface by fluororesin coating, metal oxide coating, or the like, may be applied, for example.

It is noted that the inner wall surface of only one of the adsorption tower 3 and the standby unit 7 may be subjected to the surface process.

In the present embodiment 8, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 8 is obtained by performing a surface process for suppressing ozone decomposition on the inner wall surfaces of the adsorption tower 3 and the standby unit 7 of the ozone supply device 100 of embodiment 1, for the purpose of suppressing ozone decomposition in the standby step. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, ozone decomposition at the inner surfaces of the adsorption tower and the standby unit in the standby step is suppressed, whereby the ozone usage efficiency can be further increased.

### Embodiment 9

An ozone supply device of embodiment 9 is configured by providing a liquid supply unit and a gas-liquid mixing device to the ozone supply device 100 of embodiment 1, under the assumption of supplying ozone in a solution state to the processing target.

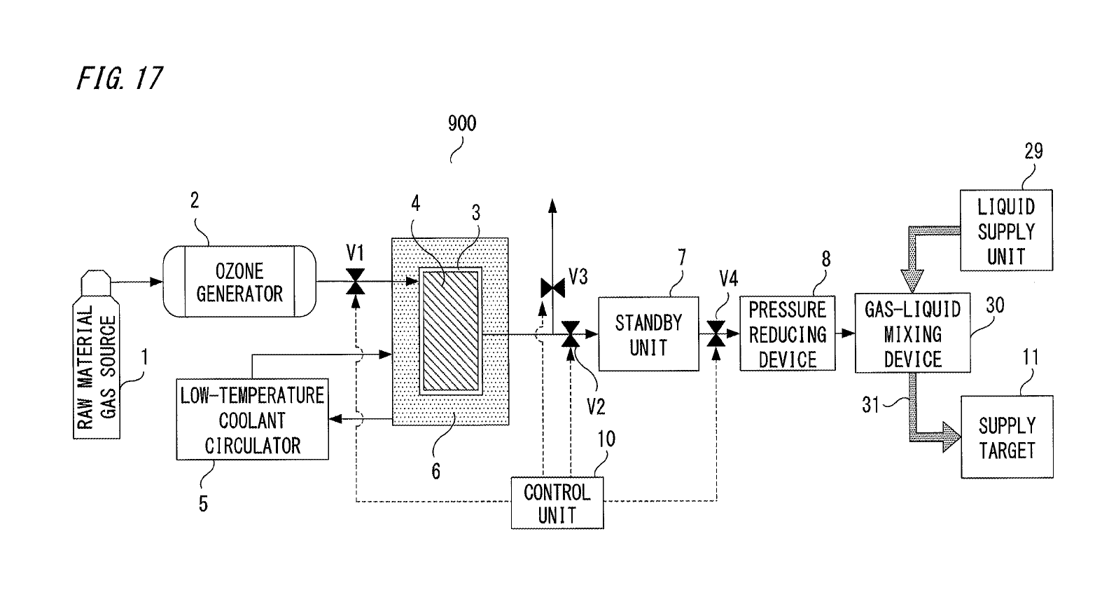

Hereinafter, the ozone supply device of embodiment 9 will be described focusing on the difference from embodiment 1, with reference to FIG. 17 which is a system schematic diagram showing the configuration thereof. In FIG. 17, parts that are the same as or correspond to those in FIG. 1 in embodiment 1 are denoted by the same reference characters.

The basic configuration of the ozone supply device 900 in embodiment 9 is the same as that of the ozone supply device 100 in embodiment 1, but the ozone supply device 900 is provided with a liquid supply unit 29 and a gas-liquid mixing device 30 under the assumption of supplying ozone in a solution state to the processing target.

As a liquid therefor, mainly, water is often used, but in some cases, a solution to which a pH conditioner such as acid or hydroxide is added, or slurry can be used, for example.

An example of a processing device that requires to supply ozone in a solution state to the processing target is a cleaning device for a filter or a separation membrane in water and sewage treatment.

As the gas-liquid mixing device 30, an ejector or a diffuser pipe is used, for example.

When an ozone request occurs from the supply target 11, the control unit 10 controls the liquid supply unit 29 to supply a liquid to the gas-liquid mixing device 30. At a point when preparation for gas-liquid mixing has been made, the control unit 10 opens the valve V2 and the valve V4, sucks the ozonized gas from the adsorption tower 3 and the standby unit 7 using the pressure reducing device 8, and supplies the ozonized gas to the gas-liquid mixing device 30, to generate an ozone solution 31.

Here, in the case of using an ejector or a diffuser pipe as the gas-liquid mixing device 30, it is desirable that the ozonized gas to be supplied to the gas-liquid mixing device 30 has a positive pressure, in order to prevent reverse flow of the liquid.

In this case, as the pressure reducing device 8, a vacuum pump or the like that allows the primary side (preceding stage) of the pressure reducing device 8 to have a negative pressure and the secondary side (subsequent stage) to have a positive pressure, is suitable. However, if the secondary side of the pressure reducing device 8 has a positive pressure, the ozonized gas on the secondary side has high ozone purity and a positive pressure, and therefore the partial pressure of ozone becomes very high, so that ozone self-decomposition reaction becomes active. Therefore, it is desirable that a gas flow path connecting the pressure reducing device 8 and the gas-liquid mixing device 30 is as short as possible.

By providing the liquid supply unit 29 and the gas-liquid mixing device 30, even for the supply target 11 that requires ozone processing in liquid phase, the ozone solution 31 can be supplied immediately in response to an ozone request, and in addition, since ozone self-decomposition during the standby state is suppressed, the ozone usage efficiency is increased.

In the present embodiment 9, as in the ozone supply device 101 (FIG. 6), the standby unit 7 may be cooled by the low-temperature coolant 6. As in the ozone supply device 102 (FIG. 7), the adsorption tower 3 may also have a function as the standby unit 7. As in the ozone supply device 103 (FIG. 8), an oxygen recycling mechanism may be provided. As in the ozone supply device 104 (FIG. 9), a raw material gas introduction line for ozone purity adjustment may be provided.

As described above, the ozone supply device of embodiment 9 is configured by providing the liquid supply unit and the gas-liquid mixing device to the ozone supply device 100 of embodiment 1, under the assumption of supplying ozone in a solution state to the processing target. Therefore, as in the ozone supply device of embodiment 1, a high-purity ozonized gas can be supplied immediately when an ozone request occurs from the supply target, ozone consumption during the standby state is reduced, and the ozone usage efficiency can be increased. Further, even for the supply target that requires ozone processing in liquid phase, the ozone solution can be supplied immediately in response to an ozone request.

Within the scope of the present invention, the above embodiments may be freely combined with each other, or each of the above embodiments may be modified or simplified as appropriate.

### INDUSTRIAL APPLICABILITY

The present invention enables improvement in responsiveness of supply of concentrated ozone upon an ozone request and enables increase in ozone usage efficiency. Therefore, the present invention is widely applicable to ozone supply devices and ozone supply methods for concentrating and storing ozone.

1. An ozone supply device comprising:
an ozone generator for generating an ozonized gas;
an adsorption tower for causing the generated ozonized gas to be adsorbed to an adsorbent inside the adsorption tower;
a standby unit for causing the ozonized gas desorbed from the adsorbent in the adsorption tower to stand by;
a pressure reducing device for reducing pressures of the adsorption tower and the standby unit;
an ozone supply unit for supplying the desorbed ozonized gas to a supply target;
a low-temperature coolant circulator for cooling the adsorbent; and
a control unit which controls a gas flow in a gas flow path connecting the ozone generator, the adsorption tower, the standby unit, and the pressure reducing device, so as to cause the generated ozonized gas to be adsorbed to the cooled adsorbent, and to desorb the ozonized gas adsorbed to the adsorbent, thereby concentrating ozone, wherein
the control unit performs control so that a pressure in the adsorption tower in a standby state where the desorbed ozonized gas is caused to stand by in the standby unit becomes lower than a pressure in the adsorption tower in the adsorption.

2. The ozone supply device according to claim 1, wherein
the pressure reducing device is provided at a stage preceding to the supply target, and
at a time of supplying the ozonized gas to the supply target, the pressure reducing device causes a pressure in the adsorption tower to be lower than a gas-phase pressure of the supply target.

3. The ozone supply device according to claim 1, further comprising a pressure gauge on the gas flow path between the adsorption tower and the standby unit, wherein
the control unit performs shifting to the standby state on a condition that a pressure in the adsorption tower has become lower than a predetermined pressure.

4. The ozone supply device according to claim 1, further comprising an ozone meter on the gas flow path between the adsorption tower and the standby unit, wherein
the ozone meter measures a partial pressure of ozone in the gas flow path, and
the control unit sets, as a step shift condition, an optional partial pressure of ozone lower than a partial pressure of ozone in the ozonized gas introduced from the ozone generator into the adsorption tower in the adsorption, and performs shifting to the standby state on a condition that a partial pressure of ozone in the adsorption tower has become lower than the partial pressure of ozone set as the step shift condition.

5. The ozone supply device according to claim 1, further comprising an ozone meter on the gas flow path between the adsorption tower and the standby unit, wherein
the ozone meter measures ozone purity in the gas flow path, and
the control unit performs shifting to the standby state on a condition that ozone purity in the adsorption tower has reached purity equal to or higher than predetermined ozone purity.

6. The ozone supply device according to claim 1, further comprising a thermometer for measuring a temperature in the adsorption tower, and a temperature adjusting device for adjusting a temperature of the adsorbent, wherein
the control unit controls a temperature of the adsorbent in the standby state to be equal to or lower than a temperature of the adsorbent in the adsorption.

7. The ozone supply device according to claim 1, further comprising a communication unit for performing signal transmission/reception between the supply target and the control unit, wherein
when an ozone request occurs from the supply target, the control unit receives the ozone request, and controls the pressure reducing device and the gas flow to supply the ozonized gas to the supply target.

8. The ozone supply device according to claim 1, wherein
the standby unit comprises a plurality of standby units provided in parallel, and
the concentrated ozonized gas is supplied to one or a plurality of the supply targets.

9. The ozone supply device according to claim 1, further comprising a storage unit for storing at least one of an ozone supply interval and an ozone supply time, wherein
the control unit estimates a next ozone supply timing, using ozone supply data accumulated in the storage unit, and controls the ozone generator and the gas flow so that the adsorption and the concentration are completed immediately before the ozone supply timing.

10. The ozone supply device according to claim 1, wherein
both or one of the adsorption tower and the standby unit has an inner wall surface subjected to a process for suppressing ozone decomposition.

11. The ozone supply device according to claim 1, wherein
the ozone supply unit includes a liquid supply unit and a gas-liquid mixing device, wherein
the concentrated ozonized gas is dissolved in a liquid using the gas-liquid mixing device, to generate an ozone solution, and the ozone solution is supplied to the supply target.

12. An ozone supply method using an ozone supply device including an ozone generator, an adsorption tower the inside of which is filled with an adsorbent, a standby unit for causing an ozonized gas to stand by, a pressure reducing device, an ozone supply unit for supplying the ozonized gas, and a low-temperature coolant circulator for cooling the adsorbent, the ozone supply method comprising:
an adsorption step of introducing an ozonized gas generated by the ozone generator into the adsorption tower, and causing the ozonized gas to be adsorbed to the cooled adsorbent;
a concentration step of reducing a pressure of the adsorption tower by the pressure reducing device, to increase ozone purity of a gas in the adsorption tower;
a standby step of sealing a concentrated high-purity ozonized gas inside the adsorption tower and the standby unit having reduced pressures, and standing by; and
a supply step of supplying the high-purity ozonized gas.

13. The ozone supply device according to claim 2, further comprising a pressure gauge on the gas flow path between the adsorption tower and the standby unit, wherein
the control unit performs shifting to the standby state on a condition that a pressure in the adsorption tower has become lower than a predetermined pressure.

14. The ozone supply device according to claim 2, further comprising an ozone meter on the gas flow path between the adsorption tower and the standby unit, wherein
the ozone meter measures a partial pressure of ozone in the gas flow path, and
the control unit sets, as a step shift condition, an optional partial pressure of ozone lower than a partial pressure of ozone in the ozonized gas introduced from the ozone generator into the adsorption tower in the adsorption, and performs shifting to the standby state on a condition that a partial pressure of ozone in the adsorption tower has become lower than the partial pressure of ozone set as the step shift condition.

15. The ozone supply device according to claim 2, further comprising an ozone meter on the gas flow path between the adsorption tower and the standby unit, wherein
the ozone meter measures ozone purity in the gas flow path, and
the control unit performs shifting to the standby state on a condition that ozone purity in the adsorption tower has reached purity equal to or higher than predetermined ozone purity.

16. The ozone supply device according to claim 2, further comprising a thermometer for measuring a temperature in the adsorption tower, and a temperature adjusting device for adjusting a temperature of the adsorbent, wherein
the control unit controls a temperature of the adsorbent in the standby state to be equal to or lower than a temperature of the adsorbent in the adsorption.

17. The ozone supply device according to claim 2, further comprising a communication unit for performing signal transmission/reception between the supply target and the control unit, wherein
when an ozone request occurs from the supply target, the control unit receives the ozone request, and controls the pressure reducing device and the gas flow to supply the ozonized gas to the supply target.

18. The ozone supply device according to claim 2, wherein
the standby unit comprises a plurality of standby units provided in parallel, and
the concentrated ozonized gas is supplied to one or a plurality of the supply targets.

19. The ozone supply device according to claim 3, further comprising an ozone meter on the gas flow path between the adsorption tower and the standby unit, wherein
the ozone meter measures a partial pressure of ozone in the gas flow path, and
the control unit sets, as a step shift condition, an optional partial pressure of ozone lower than a partial pressure of ozone in the ozonized gas introduced from the ozone generator into the adsorption tower in the adsorption, and performs shifting to the standby state on a condition that a partial pressure of ozone in the adsorption tower has become lower than the partial pressure of ozone set as the step shift condition.

20. The ozone supply device according to claim 3, further comprising an ozone meter on the gas flow path between the adsorption tower and the standby unit, wherein
the ozone meter measures ozone purity in the gas flow path, and
the control unit performs shifting to the standby state on a condition that ozone purity in the adsorption tower has reached purity equal to or higher than predetermined ozone purity.
